(19) United States
(12) Patent Application Publication
(10) Pub. No.: US 2012/0013947 A1
(43) Pub. Date: Jan. 19, 2012

(54) PRINT DATA RECEIVING APPARATUS, PRINT DATA RECEIVING METHOD AND PRINT DATA RECEIVING PROGRAM

(75) Inventor: Yoshimi Nakayama, Hino-shi (JP)

(73) Assignee: KONICA MINOLTA BUSINESS TECHNOLOGIES, INC., Chiyoda-ku (JP)

(21) Appl. No.: 13/178,022

(22) Filed: Jul. 7, 2011

(30) Foreign Application Priority Data
Jul. 15, 2010 (JP) 2010-160675

(51) Int. Cl. G06K 15/02

(52) U.S. Cl. 358/1.15

(57) ABSTRACT

A print data receiving apparatus for receiving pint data from an external, equipped with a first arithmetic unit for controlling at least a first storage device for storing the print data, and a second arithmetic unit for issuing an activation command to the first arithmetic unit and controlling a second storage device for temporarily storing the received print data when the print data is received from the external under a power saving mode that stops operation of the first arithmetic unit. The second arithmetic unit consumes less power than the first arithmetic unit and controls receiving speed of the print data in such a manner as to cause a free space of the second storage device to be used up when an activation of the first arithmetic unit is completed.

### CROSS-REFERENCE TO RELATED APPLICATION

This application is based on Japanese Patent Application No. 2010-160675, filed on Jul. 15, 2010, the contents of which are incorporated herein by reference.

### BACKGROUND

1. Technical Field

The present invention relates to a print data receiving apparatus, a print data receiving method, and a print data receiving program.

2. Description of Related Art

In the midst of trends demanding energy-saving in all sorts of industrial activities, image forming apparatuses such as printers are designed to cut unnecessary power consumption by stopping power supply to a fixing device when the apparatus is not being operated for a certain period of time. However, since power supply to other key components that consume large amounts of power, such as the arithmetic unit of a printer controller, is not interrupted as it is necessary in order to detect external events such as receiving of print data from a network, so that there has been a limit to the power-saving effort.

In the meanwhile, a technique has been invented allowing to cut the power supply to the main arithmetic unit by mounting a sub arithmetic unit that monitors the network and activates the main arithmetic unit when print data is received (e.g., Unexamined Japanese Patent Publication No. 2005-94679).

However, while it is necessary to temporarily keep the print data received from the network by the storage device of the sub arithmetic unit until the activation of the main arithmetic unit is completed, there is a problem that its storage capacity is limited. For example, the received print data may overflow from the storage device if the print data receiving speed is too large, or may cause the time-out on the print data transmitting side and an interruption of the transmission if the receiving speed is reduced to avoid the overflow. On the other hand, even if the print data receiving speed is adjusted in advance, the activation time of the main arithmetic unit may not be the same so that it may be difficult to receive the print data efficiently.

### SUMMARY

Objects of the invention are to provide a print data receiving apparatus, a print data receiving method, and a print data receiving program capable of reducing power consumption and efficient reception of print data.

To achieve at least one of the aforementioned objects, the print data receiving apparatus that receives print data from an external, reflecting one aspect of the present invention, comprises: a first arithmetic unit that controls at least a first storage device for storing the print data; and a second arithmetic unit that issues an activation command to the first arithmetic unit when the second arithmetic unit detects receipt of the print data from the external under a power saving mode that stops operation of the first arithmetic unit, and controls a second storage device for temporarily storing the print data that is received, wherein the second arithmetic unit consumes less power than the first arithmetic unit and controls a receiving speed of the print data in such a manner as to cause a free space of the second storage device to be used up when an activation of the first arithmetic unit is completed.

To achieve at least one of the aforementioned objects, a print data receiving method for receiving print data from an external, reflecting another aspect of the present invention, comprises: in case when receipt of the print data from the external is detected under a power saving mode in which a first arithmetic unit for controlling at least a first storage device that stores the print data is stopped, a step of issuing an activation command to the first arithmetic unit by a second arithmetic unit that consumes less power than the first arithmetic unit, and controlling a second storage device for temporarily storing the print data that is received, wherein a receiving speed of the print data is controlled in the step in such a manner as to cause a free space of the second storage device to be used up when an activation of the first arithmetic unit is completed.

To achieve at least one of the aforementioned objects, a computer readable recording medium stored with a print data receiving program for controlling a print data receiving apparatus comprising a first arithmetic unit for controlling at least a first storage device for receiving print data from an external and storing the print data, and a second arithmetic unit for controlling a second storage device for temporarily storing the print data in which the second arithmetic unit consumes less power than the first arithmetic unit, the print data receiving program causing the print data receiving apparatus to execute a process, reflecting another aspect of the present invention, comprising: a step of, in case when receipt of the print data from the external is detected under a power saving mode in which the first arithmetic unit is stopped, issuing an activation command to the first arithmetic unit and controlling the second storage device to temporarily store the print data that is received by means of the second arithmetic unit, wherein a receiving speed of the print data is controlled in the step in such a manner as to cause a free space of the second storage device to be used up when an activation of the first arithmetic unit is completed.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a block diagram illustrating a printing system according to a first embodiment of the present invention.

FIG. 2 is a block diagram illustrating the printer shown in FIG. 1.

FIG. 3 is a flowchart of assistance in explaining the power-saving mode control by a CPU mounted on the board shown in FIG. 2.

FIG. 4 is a flowchart of assistance in explaining the receiving speed control by a CPU mounted on the sub-board shown in FIG. 2.

FIG. 5 is a flowchart of assistance in explaining a response interval setting process of step S129 shown in FIG. 4.

FIG. 6 is a table of assistance in explaining a primary adjustment condition of step S142 shown in FIG. 5.

FIG. 7 is a table of assistance in explaining a secondary adjustment condition of step S143 shown in FIG. 5.

FIG. 8 is a graph of assistance in explaining the transition of receiving speed in case when a removable storage device is not mounted on the main-board.

FIG. 9 is a graph of assistance in explaining the transition of free space of a RAM of the sub-board in case when a removable storage device is not mounted on the main-board.

FIG. 10 is a graph of assistance in explaining the transition of receiving speed in case when a removable storage device is mounted on the main-board.

FIG. 11 is a graph of assistance in explaining the transition of free space of the RAM of the sub-board in case when a removable storage device is mounted on the main-board.

FIG. 12 is a block diagram illustrating a printer according to a second embodiment of the present invention.

FIG. 13A is a flowchart of assistance in explaining the power-saving mode control by a CPU mounted on the main-board shown in FIG. 12.

FIG. 13B is a flowchart continued from FIG. 13A.

FIG. 14A is a flowchart of assistance in explaining the receiving speed control by a CPU mounted on the sub-board shown in FIG. 12.

FIG. 14B is a flowchart continued from FIG. 14A.

FIG. 15 is a table of assistance in explaining a primary adjustment condition of step S229 shown in FIG. 14B.

FIG. 16 is a graph of assistance in explaining the transition of receiving speed in case when only a small number of files are stored in an HDD of the main-board.

FIG. 17 is a graph of assistance in explaining the transition of free space of a RAM of the sub-board in case when only a small number of files are stored in the HDD of the main-board.

FIG. 18 is a graph of assistance in explaining the transition of receiving speed in case when a large number of files are stored in the HDD of the main-board.

FIG. 19 is a graph of assistance in explaining the transition of free space of the RAM of the sub-board in case when a large number of files are stored in the HDD of the main-board.

### DETAILED DESCRIPTION

The embodiments of the present invention will be described in detail below with reference to the accompanying drawings.

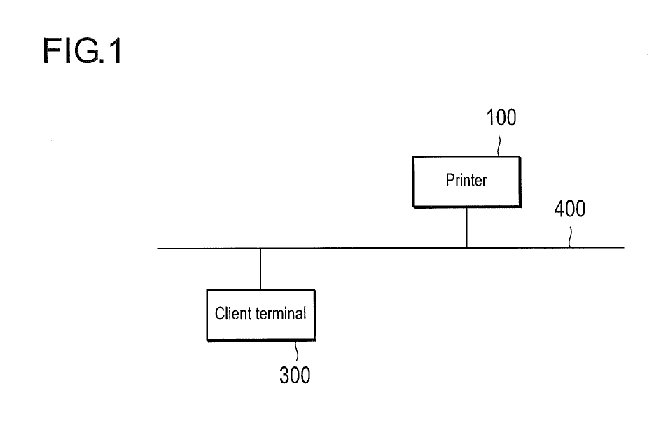

FIG. 1 is a block diagram illustrating a printing system according to a first embodiment of the present invention.

A printer 100 according to the first embodiment is used for conducting a printing process by receiving print data transmitted from a client terminal 300 connected to it via a network 400, and is capable of receiving print data efficiently and minimizing power consumption.

The network 400 may include various networks that connect computers and network equipment with each other based on standards such as Ethernet®, Token Ring, and FDDI (Fiber-Distributed Data Interface), for example, LAN (Local Area Network), WAN (Wide Area Network) that connects LANs via dedicated lines, the Internet, a combination thereof. The network protocol used here is, for example, TCP/IP (Transmission Control Protocol/Internet Protocol). The types and quantities of equipment to be connected to the network 400 are not limited to the example shown in FIG. 1.

The client terminal 300 is a computer including a main unit, a display, and an input device, and is installed with various application programs. The application programs include a word-processing program for creating electronic documents and a driver program for printing the electronic documents. The standards of electronic documents include XPS (XML Paper Specification) and PDF (Portable Document Format).

The driver program generates print data in a description language format that is compatible with the printer 100 and transmits it to the printer 100 as a print job via the network 400. The description language format is a PDL (Page Description Language) such as PostScript® and PCL (Printer Control Language).

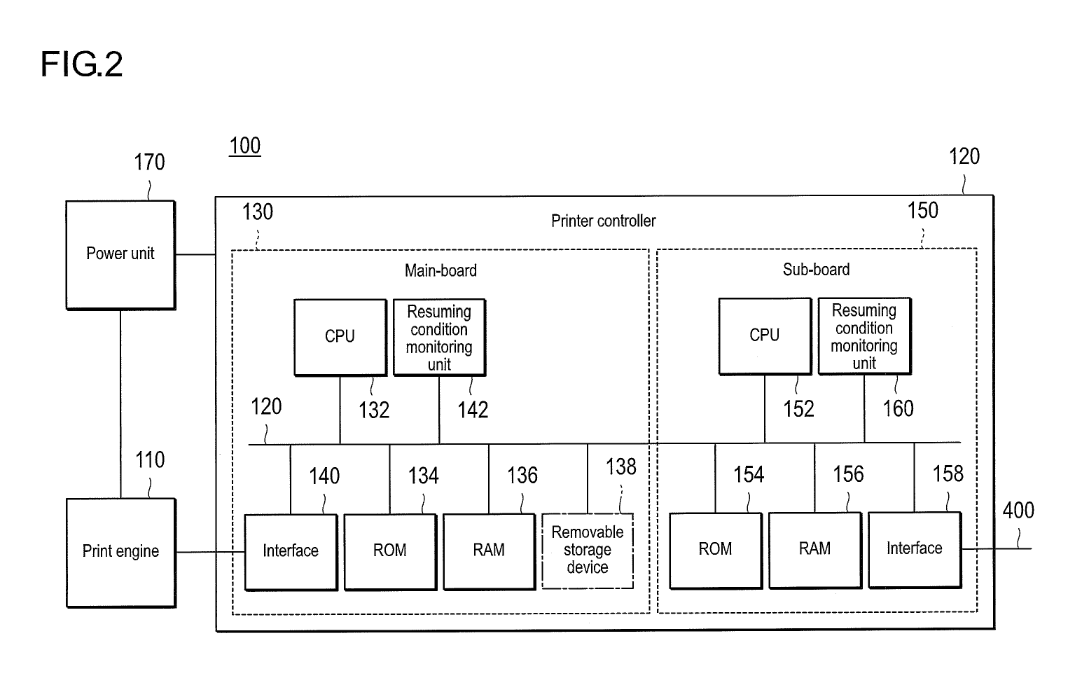

FIG. 2 is a block diagram illustrating the printer 100 shown in FIG. 1.

The printer 100 includes a print engine 110 and a printer controller 120, to which electric power is supplied from a power unit 170. The print engine 110 is equipped with an engine that forms an image on a sheet of paper, i.e., a recording medium, using imaging forming processes, such as an electronic photographing process that includes charging, exposing, developing, transferring, and fixing processes, etc.

The printer controller 120 consists of a plated circuit with a main-board 130 and a sub-board 150.

The main-board 130 is used to convert print data (e.g., PDL data) received from the client terminal 300 into raster data and to transfer it to the print engine 110, and has a CPU 132, a ROM 134, a RAM 136, a removable storage device 138, an engine interface 140, and a resuming condition monitoring unit 142, all of which are connected with each other via a bus 122.

The CPU 132 is a main arithmetic unit with a microprocessor that controls the aforementioned various parts and executes various arithmetic processes according to programs, and various functions of the main-board 130 are realized as the CPU 132 executes the corresponding programs.

The ROM 134 is a read-only storage device for storing various programs and data. The programs stored in the ROM 134 include the program for the power-saving mode to minimize the power consumption of the CPU 132 of the main-board 130, the program for the RIP (Raster Image Processing) of the received print data (PDL data transferred from the client terminal 300), etc. The RAM 136 is a high speed random access storage device for temporarily storing programs and data as a work area, and is used for storing print data when the removable storage device 138 is not mounted.

The removable storage device 138 may be an HDD (hard disk device), a CF (Compact Flash) card, and a USB memory, and is used as an optional storage device for storing various programs and data.

The engine interface 140 is a dedicated interface, i.e. VIF (Video Interface) for communicating with the print engine 110.

The resuming condition monitoring unit 142 is designed in such a way as to be able to operate even when the power to the CPU 132 is turned off (no power supply), and is used to restart the power supply to the CPU 132 in order to activate the CPU 132 based on the activation command from the CPU 152 of the sub-board 150.

The sub-board 150 is provided for efficient reception of printing data under the power-saving mode for the CPU 132 of the main-board 130 under the power-saving mode, and includes a CPU 152, a ROM 154, a RAM 156, a communication interface 158, and a resuming condition monitoring unit 160, all of which are connected with each other via the bus 122.

The CPU 152 is a sub arithmetic unit with a microprocessor that controls the aforementioned various parts and executes various arithmetic processes according to programs, and various functions of the sub-board 150 are realized as the CPU 152 executes the corresponding programs.

The ROM 154 is a read-only storage device for storing various programs and data. The programs stored in the ROM 154 include a program for controlling the receiving speed for efficiently receiving the print data, etc.

The receiving speed is controlled in such a manner that no free space will be left in the RAM 156 when the activation of the CPU 132 of the main-board 130 is completed, and can be modified by adjusting the response interval to the client terminal 300 that transmits the print data. The response interval is defined as the time period for returning an ack signal after receiving a packed that constitutes the print data from the client terminal 300, and the relation is such that the receiving speed increases when the response intervals shortens, while the receiving speed reduces when the response interval elongates. If the time-out limit as a point of reference for resending of the print data from the client terminal 300 is, for example, 3 seconds, the response interval can be set within 0-3 seconds.

The response interval is adjusted based on an actual time period halfway through the activation and the specification of the removable storage device 138. The reason for checking whether or not the removable storage device 138 is mounted is that it affects the processing time for initializing the OS (operating system), and increases the activation time of the CPU 132 of the main board 130.

The RAM 156 is a high speed random access storage device for temporarily storing programs and data as a work area, and is used for temporarily storing or memorizing the print data received during the power-saving mode for the CPU 132 of the main-board. The stored print data is transferred to the main-board 130 via the bus 122 after the main-board 130 is activated. Since the sub-board 150 is designed especially for the network processing, the capacity of the RAM 156 is, e.g., a few 10 kbytes.

In order to avoid an overflow of the print data in the RAM 156 of the sub-board 150, it is necessary that the data amount of the packets received during the period until the activation of the CPU 132 of the main-board 130 is completed is less than the usable capacity of the RAM 156 of the sub-board 150. Therefore, let the usable capacity of the RAM 156 be M (byte), the packet size be m (byte), the time until the activation of the CPU 132 of the main-board 130 is completed be T (s), and the response interval be X (s), we get the formula

X(s)=T/(M/m).

The communication interface 158 is a communication unit consisting of so-called LAN board serving as an expansion device for adding a communication function to the printer 100 in order to communicate with the network 400.

The resuming condition monitoring unit 160 is designed in such a way as to be able to operate even when the power to the CPU 152 is turned off (when the CPU 152 is not operating), and is used to restart the power supply to the CPU 152 in order to activate the CPU 152 in response to the start notification of the power-saving mode of the CPU 132 of the main-board 130.

The power unit 170 is designed in such a way as to be able supply power independently to various units of the printer 100; for example, it can stop the power supply to the CPU 132 of the main-board 130, while supplying power to the CPU 152 of the sub-board 150. The power consumption of the sub-board 150 is, e.g., approximately 1 W, and is adapted to be smaller than the power consumption of the main-board 130. Therefore, it is possible to minimize the power consumption by stopping the power supply to the main-board 130, while activating only the sub-board 150 to keep monitoring the network, and causing it to make a judgment whether or not the resuming is necessary during the power-saving mode.

The connection between the printer 100 and the client terminal 300 does not have to be limited to a connection via the network, but also can be accomplished by a direct connection using a serial interface such as USB (Universal Serial Bus) or a parallel interface such as IEEE (Institute of Electrical and Electronics Engineers) 1284. Also, the printer controller 120 does not have to be consisted of separate entities, the main-board 130 and the sub-board 150.

Let us now describe the power-saving mode.

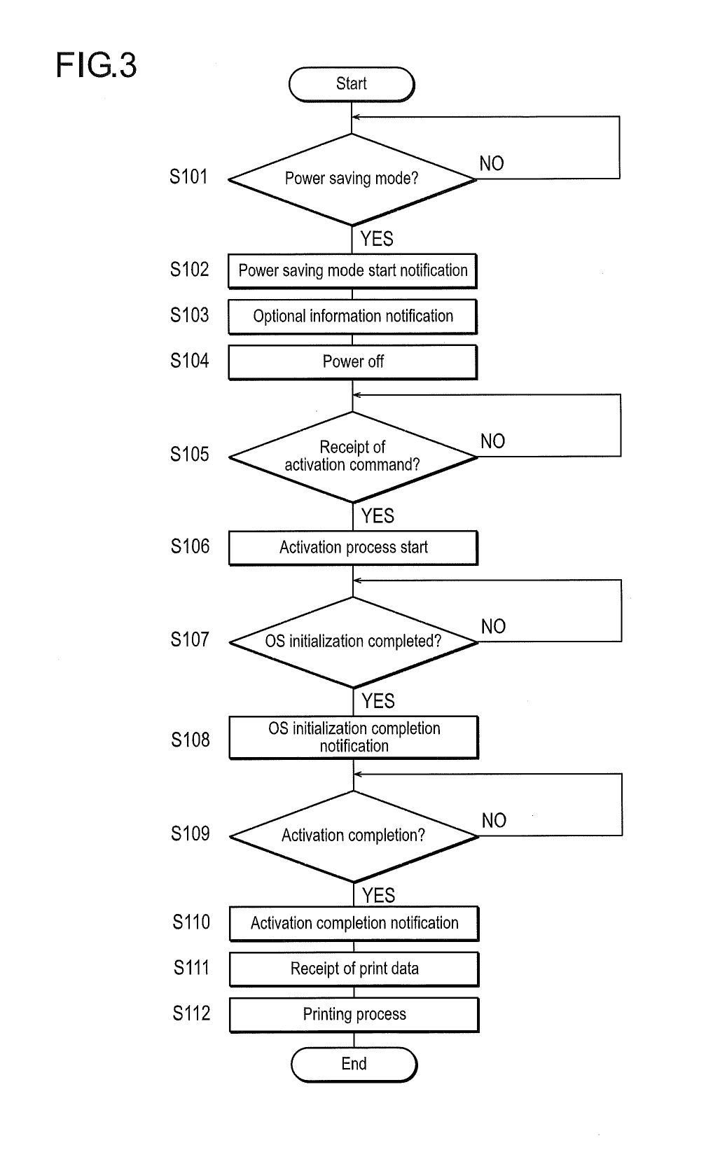

FIG. 3 is a flowchart of assistance in explaining the power-saving mode control by the CPU mounted on the main-board shown in FIG. 2. The algorithm shown in the flowchart of FIG. 3 is stored as the program in the ROM 134 and is executed by the CPU 132.

First, a judgment is made as to whether the power-saving mode condition is fulfilled or not (step S101). The power-saving mode condition is that no process is performed for a certain period of time, and may be detected by the time-out of the monitoring timer, for example.

In case if it is found that the power-saving mode condition is fulfilled (step S101: Yes), the start of the power-saving mode of the CPU 132 of the main-board 130 and the optional information concerning the removable storage device 138 are notified (steps S102 and S103). The optional information is about whether the removable storage device 138 is mounted or not, and the specification (type and capacity) of the removable storage device 138. It is also possible to constitute the optional information to include other kinds of information concerning the processing during the activation, e.g., the number of files stored in the removable storage device 138, and as to whether there was any access to the removable storage device 138 during the activation. Upon receiving the notification of the start of the power-saving mode, the CPU 152 of the sub-board 150 monitors the network and waits for the receipt of the print data from the client terminal 300.

Then, all the functions of the CPU 132 are stopped and the power is turned off (step S104).

Next, a judgment is made as to whether or not an activation command is received from the CPU 152 of the sub-board 150 (step S105). The activation command is issued when the CPU 152 of the sub-board 150 starts a process of receiving print data from the client terminal 300.

When the reception of the activation command from the CPU 152 of the sub-board 150 is detected (step 105: Yes), the power-saving mode is canceled and an activation process is started (step S106). The activation process contains the activation of the CPU 132 of the main-board 130, the initialization of the RAM 136, the initialization of the removable storage device 138, the initialization of the OS, the warm-up of the fixing unit of the print engine 110, etc.

Next, a judgment is made as to whether the initialization of the OS is completed or not (step S107). If the completion of the initialization of the OS is detected (step S107: Yes), the CPU 152 of the sub-board 150 is notified of the completion of the initialization of the OS (step S108).

A judgment is made as to whether or not the activation of the CPU 132 of the main-board 130 is completed (step S109). If the completion of the activation of the CPU 132 of the main-board 130 is detected (step S109: Yes), the CPU 152 of the sub-board 150 is notified of the completion of the activation (step S110). Then, the receipt of the print data temporarily stored in the RAM 156 of the sub-board 150 begins (step S111).

When the receipt of the print data is completed, the printing process starts (step S112). In the printing process, the RIP process of the print data is executed, and the raster data finished by means of the RIP process is transferred to the print engine 110 via the engine interface 140.

Next, the receiving speed control is described in detail.

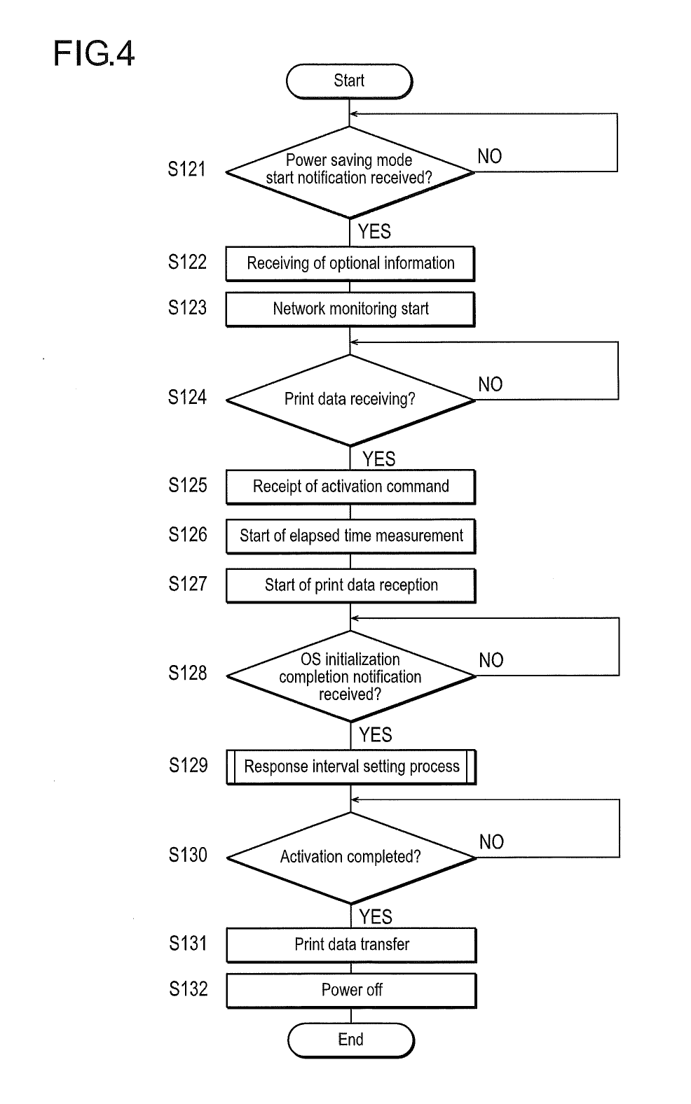

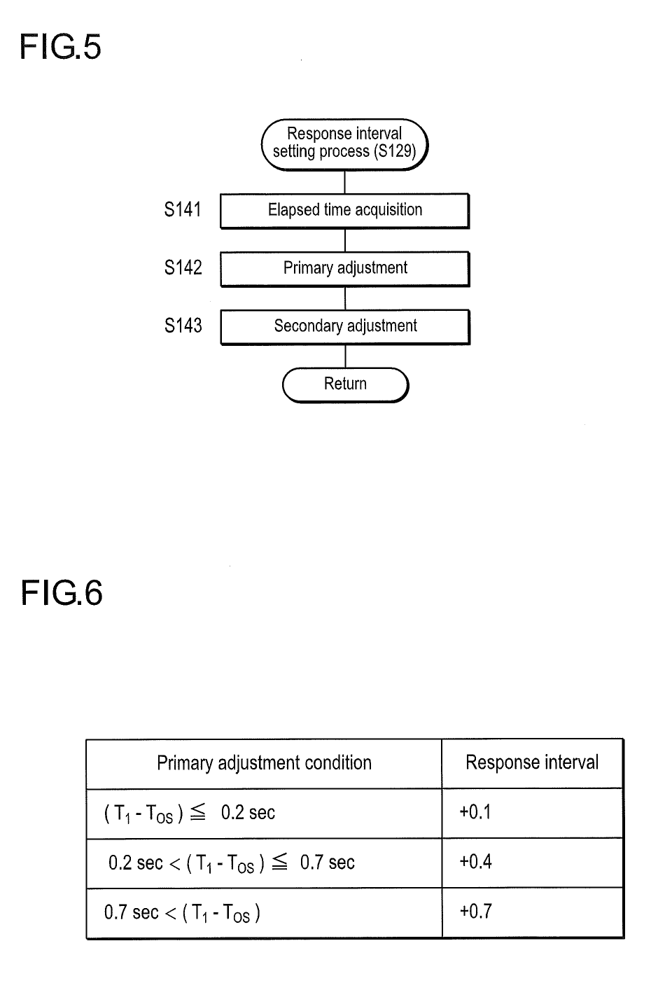

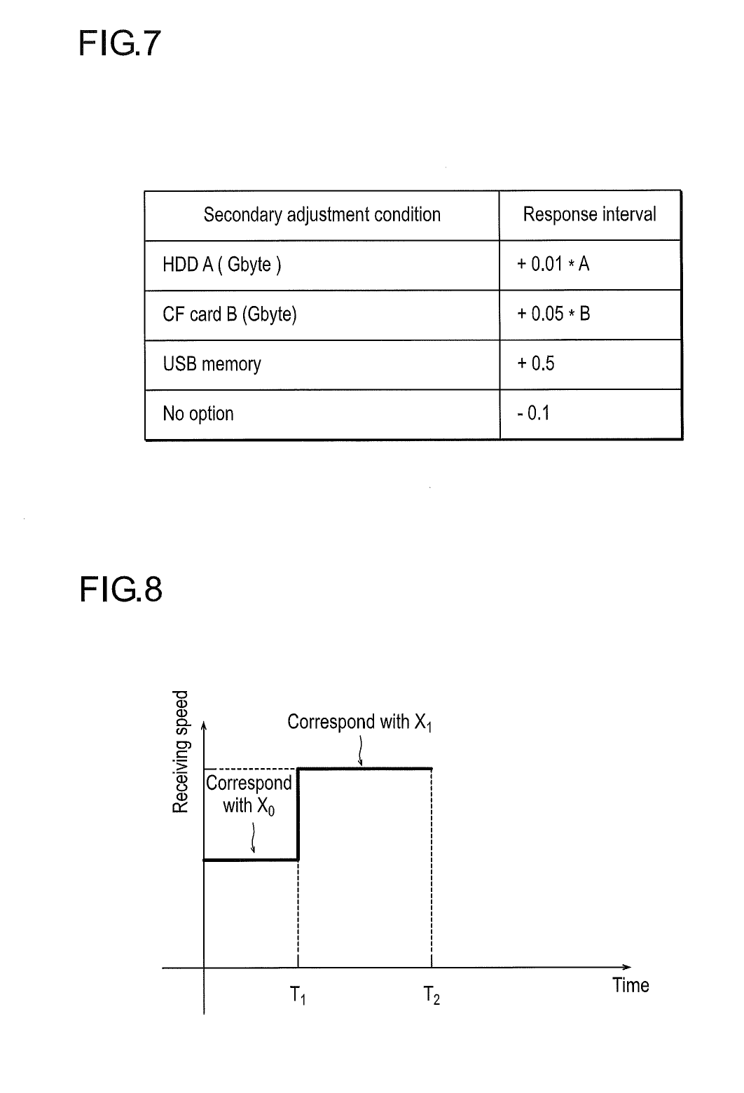

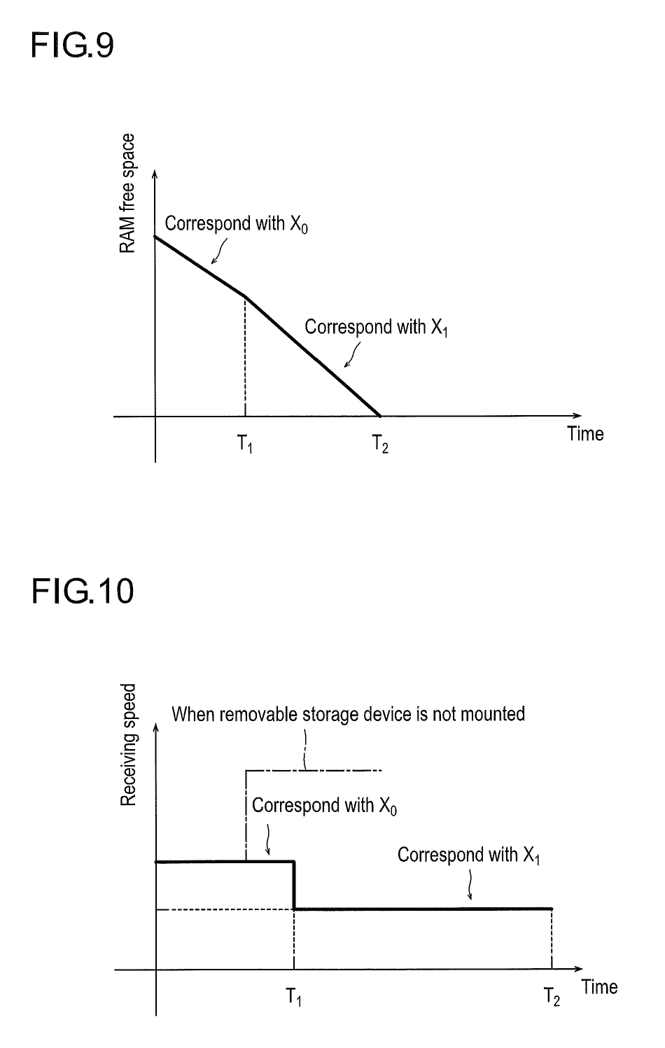

FIG. 4 is a flowchart of assistance in explaining the receiving speed control by the CPU mounted on the sub-board shown in FIG. 2, FIG. 5 is a flowchart of assistance in explaining a response interval setting process of step S129 shown in FIG. 4, FIG. 6 is a table of assistance in explaining a primary adjustment condition of step S142 shown in FIG. 5, and FIG. 7 is a table of assistance in explaining a secondary adjustment condition of step S143 shown in FIG. 5. The algorithm shown in the flowcharts of FIG. 9 and FIG. 10 is stored as the program in the ROM 154 and is executed by the CPU 152.

First, a judgment is made as to whether or not the start notification of the power-saving mode of the CPU 132 of the main-board 130 (refer to step S102) is received (step S121). If the start of the power-saving mode is detected (step S122: Yes), the optional information concerning the removable storage device 138 (refer to step S103) is received from the CPU 132 of the main-board 130 (step S122), and the monitoring of the network starts (step: S123).

Next, a judgment is made as to whether or not the print data is received from the client terminal 300 (step S124). If the receipt of the printing data is detected (step S124: Yes), the activation command (refer to step S105) is issued to the CPU 132 of the main-board 130 (step S125), the measurement of the elapsed time starts (step S126), and the receipt of the print data from the client terminal 300 starts and it is stored in the RAM 156 temporarily (step S127).

The initial value X₀ of the response interval at the start of receiving the print data is set to the standard response interval Xs plus a margin (e.g., 0.5). The standard response interval Xs is calculated based on the actual time until the activation of the CPU 132 of the main-board 130 is completed under a condition without having the removable storage unit 138. The elapsed time is used for adjusting the response interval in the response interval setting process.

A judgment is made as to whether or not the completion notification for the initialization of the OS (step S108) is received (step S128). If the completion notification for the initialization of the OS is detected (step S128: Yes), the response interval setting process is executed (step S129).

The response interval setting process is a process of adjusting the response interval based on the elapsed time until the initialization of the OS is completed, whether or not the removable storage device 138 is mounted, the type of the removable storage device 138, and the storage capacity of the removable storage device 138. The reason for checking the storage capacity of the removable storage device 138 is that the processing time of the initialization of the OS increases with the increase of the storage capacity.

After that, a judgment is made as to whether or not the completion notification of the activation of the CPU 132 of the main-board 130 (refer to step S110) is received (step S130). When the completion notification of the activation is detected (step S130: Yes), the print data that is temporarily stored in the RAM 156 is transferred to the main-board 130 (step S131). The stopping of the receipt of the print data is executed for each job.

Then, all the functions of the CPU 152 are stopped and the power is turned off (step S132). The print data from then on is transferred from the client terminal 300 via the communication interface 158, passing through the sub-board 150, to the main-board 130.

Next, the response interval setting process is described.

First, the elapsed time T₁ until the completion of the initialization of the OS as an actual time period halfway through the activation is acquired (step S141), and the primary adjustment is executed (step S142). The response interval is adjusted in the primary adjustment based on the value, or difference obtained by subtracting the standard initialization time T_{OS} from the elapsed time T₁. The standard initialization time T_{OS} is calculated based on the time until the initialization of the OS is completed under a condition without having the removable storage unit 138.

As shown in FIG. 6, the response interval is increased by 0.1 if the difference is less than 0.2 seconds, increased by 0.4 if the difference is greater than 0.2 seconds and less than 0.7 seconds, or increased by 0.7 of the difference exceeds 0.7 seconds. In other words, since it is estimated that there will be a delay in the activation completion time of the CPU 132 of the main-board 130 as the elapsed time T₁ becomes larger than the standard initialization time T_{OS}, the overflow of the print data is avoided by reducing the receiving speed by making the response interval longer.

After that, the secondary adjustment is executed based on the optional information (step S143). In the secondary adjustment, the response interval is further adjusted in response to whether the removable storage device 138 is mounted or not as well as the types and storage capacity of the removable storage device 138. The response interval of the secondary adjustment is shown as X₁.

The response interval is increased by 0.01*A if the removable storage device 138 is an HDD of A (Gbyte) capacity, increased by 0.05*B if it is a CF card of B (Gbyte), or increased by 0.5 if it is a USB memory as shown in FIG. 7. If the removable storage device 138 is not mounted, the response interval X is reduced by 1.0. This is because an HDD is thought to prolong the activation completion time of the CPU 132 compared with a CF card and also because the activation completion time of the CPU 132 of the main-board 130 is thought to be delayed in response to the increase of storage capacity.

Moreover, the condition for the primary adjustment for the response interval and the same for the secondary adjustment are not limited to the conditions shown in FIG. 6 and FIG. 7.

Next, let us describe an example of the receiving speed control.

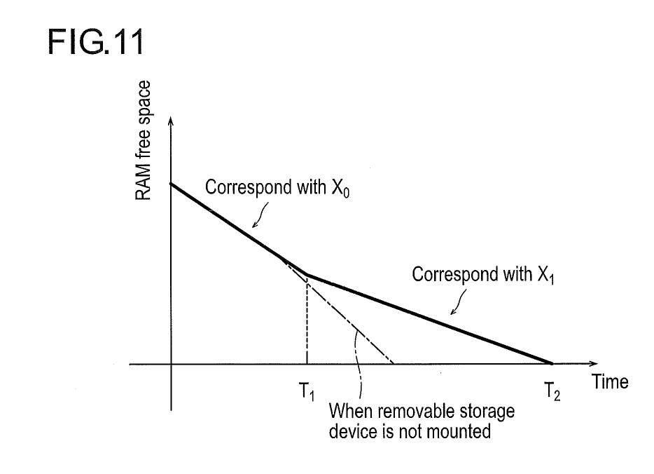

FIG. 8 and FIG. 9 are the graphs of assistance in explaining the transition of the receiving speed and the transition of the free space of the RAM of the sub-board respectively when the removable storage device is not mounted on the main-board, while FIG. 10 and FIG. 11 are the graphs of assistance in explaining the transition of the receiving speed and the transition of free space of the RAM of the sub-board respectively in case when a removable storage device is mounted on the main-board.

For example, since the activation of the CPU 132 of the main-board 130 is estimated to match approximately with the standard completion time T_{MB} in case when there is no difference between the actual elapsed time T₁ and the standard initialization time T_{OS} and also the removable storage device is not mounted, it is possible to receive the print data within a short period of time by increasing the receiving speed (by adjusting the response interval shorter) as shown in FIG. 8. In this case, the speed of free space reduction of the RAM 156 increases with the increase of the receiving speed as shown in FIG. 9. Moreover, the response interval X₁ after the adjustment can be calculated based on the packet size and the free space of the RAM 156 assuming that the remaining time (T₂−T₁)=T_{MB}−T_{OS}, for example.

On the other hand, since the activation of the CPU 132 of the main-board 130 is expected to take longer than the standard completion time T_{MB} in case when the difference between the actual elapsed time T₁ and the standard initialization time T_{OS} is large and/or when the removable storage device is mounted on the main-board 130, it is necessary to avoid the overflow of the print data by reducing the receiving speed. Consequently, the receiving speed is reduced (the response interval is adjusted longer) as shown in FIG. 10. In this case, the speed of free space reduction of the RAM 156 reduces with the reduction of the receiving speed as shown in FIG. 11.

As can be seen in the above, it is possible in the first embodiment to receive the print data within in a short period of time while avoiding the overflow of the print data as the CPU 152 of the sub-board 150 controls the receiving speed of the print data in such a way as to use up the free space of the RAM 156 of the sub-board 150 just when the activation of the CPU 132 of the main-board 150 is completed. Also, it is possible to achieve power-saving as the CPU 152 of the sub-board 150 consumes less power than the CPU 132 of the main-board 130. Thus, it is possible to provide the print data receiving apparatus, the print data receiving method, and the print data receiving program capable of reducing power consumption and efficient reception of print data.

Moreover, although the receiving speed is controlled in the first embodiment by adjusting the response interval considering the specification of the removal storage device and the actual time period halfway through the activation, the present invention should not be construed to be limited by such an embodiment. For example, it is possible to configure to consider either one of the specification of the removable storage device or the actual time period halfway through the activation, or the condition of the print engine. The receiving speed can be adjusted by modifying the packet size, or data size to be sent at a time.

The power supply to the CPU 132 of the main-board 130 is not limited to the embodiment of stopping completely. In case when a power-saving mode such as a sleep mode is available, it is possible to reduce the power consumption while maintaining the power supply by means of using the power-saving mode, for example. It is possible to allow to operate the sub-board 150 in a mode other than the power-saving mode by assigning a portion of the functions of the main-board 130. It is possible to constitute the CPU 132 and the CPU 152 as an integral unit by means of a multi-core processor having a plurality of arithmetic units.

Next, let us describe the second embodiment.

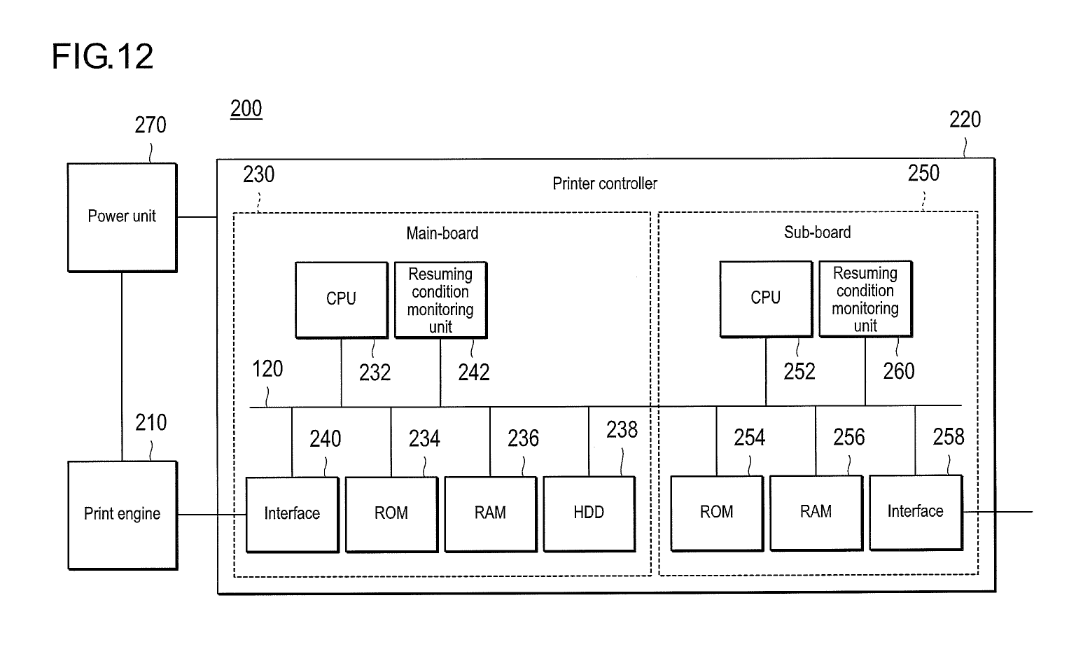

FIG. 12 is a block diagram illustrating a printer according to a second embodiment of the present invention.

The second embodiment is generally different from the first embodiment with respect to the form of a storage device of the main-board for storing print data and the mode for adjusting the response interval. In the description of the members, identical symbols are used as those for the corresponding members of the first embodiment so that their descriptions can be omitted in order to avoid duplications.

The main-board 230 of the second embodiment has the HDD 238 of a fixed type. The HDD 238 is used for a log file to be written when the CPU 232 of the main-board 230 is returned from the power-saving mode in addition for storing the print data. The log file contains the log information to be used as statistical information for a debugging purpose later. The log information is information concerning the power-saving mode start time, the power-saving mode ending time, the power-saving mode period, etc.

Moreover, the ROM 254 of the main-board 230 stores the program for the receiving speed control according to the second embodiment and others, and the response interval is adjusted by the receiving speed control considering the effects of the number of files stored in the HDD 236 and the actual time period halfway through the activation (time period until the completion of log information writing is notified).

Let us now describe the power-saving mode.

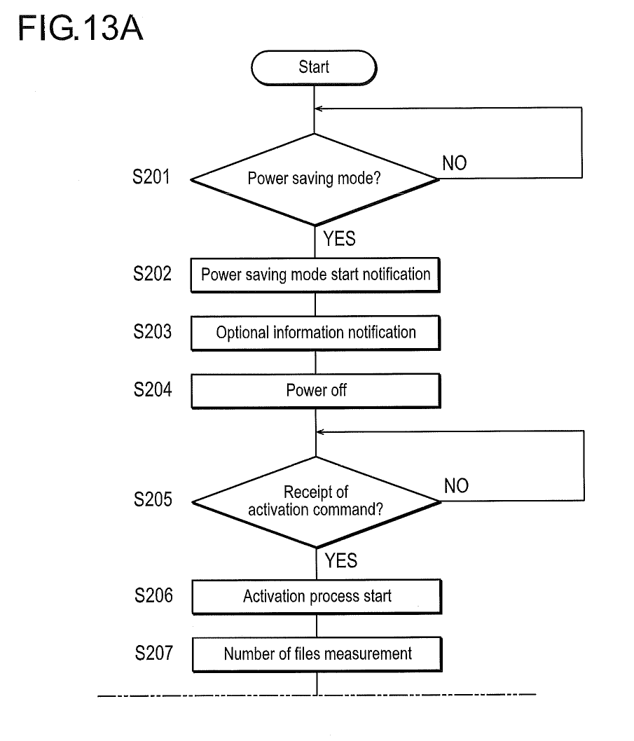

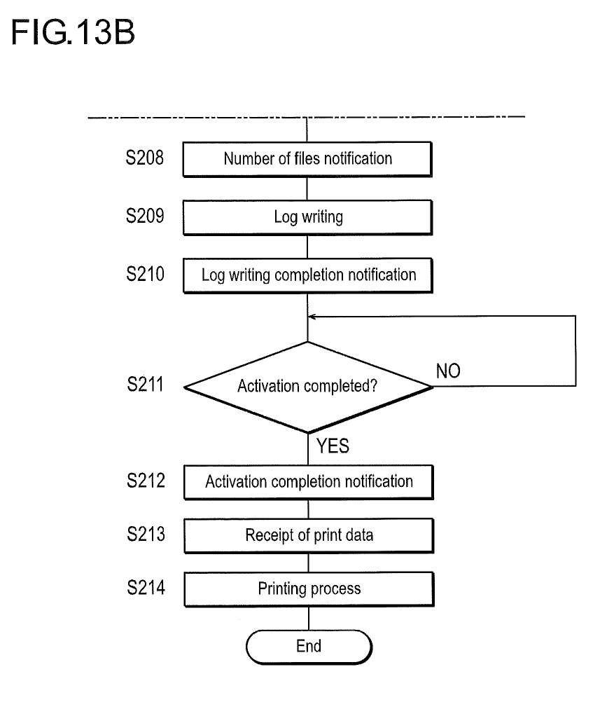

FIG. 13A and FIG. 13B show flowcharts of assistance in explaining the power-saving mode control by the CPU mounted on the main-board shown in FIG. 12. The algorithm shown in the flowcharts of FIG. 13A and FIG. 13B is stored as the program in the ROM 234 and is executed by the CPU 232.

Since the process from step S201, wherein a judgment is made as to whether or not the power-saving condition is satisfied, through step S206, wherein the power-saving mode is canceled to start the activation process in the present embodiment, substantially matches with the process from step S101 through S106 in the first embodiment, its description is omitted in order to avoid duplications.

When the activation process is started in step S206 upon the cancellation of the power-saving mode, the number of files stored in the HDD 236 is detected (step S207), and the number of files is notified to the CPU 252 of the sub-board 250 (step S208).

The log information is written into the HDD 236 (step S209). The completion of the log information writing is notified to the CPU 252 of the sub-board 250 (step S210).

After that, a judgment is made as to whether or not the activation of the CPU 232 of the main-board 230 is completed (step S211). If the completion of the activation of the CPU 232 of the main-board 230 is detected (step S211: Yes), the CPU 252 of the sub-board 250 is notified of the completion of the activation (step S212). Then, the receiving of the print data temporarily stored in the RAM 256 of the sub-board 250 begins (step S213).

When the receipt of the print data is completed, the printing process starts (step S214). In the printing process, the RIP process of the print data is executed, and the raster data finished by means of the RIP process is transferred to the print engine 210 via the engine interface 240.

Next, the receiving speed control is described.

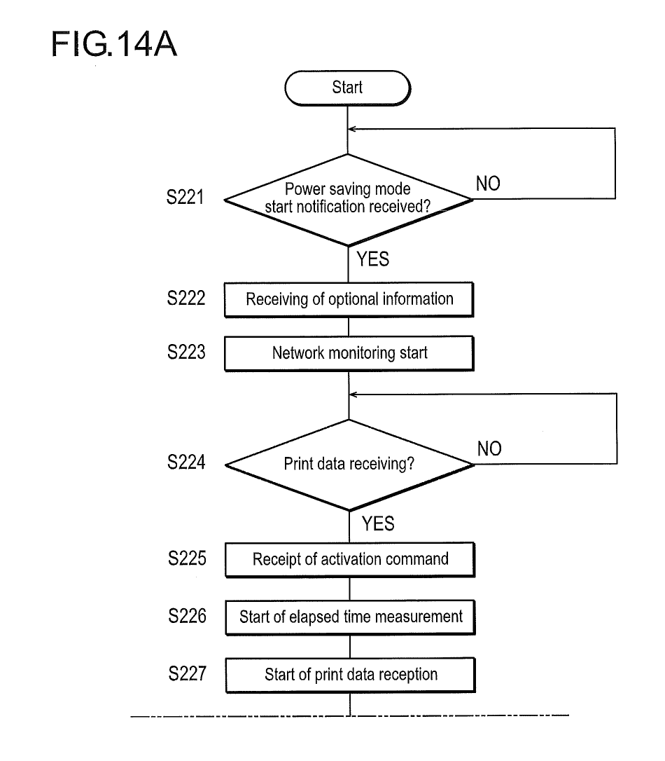

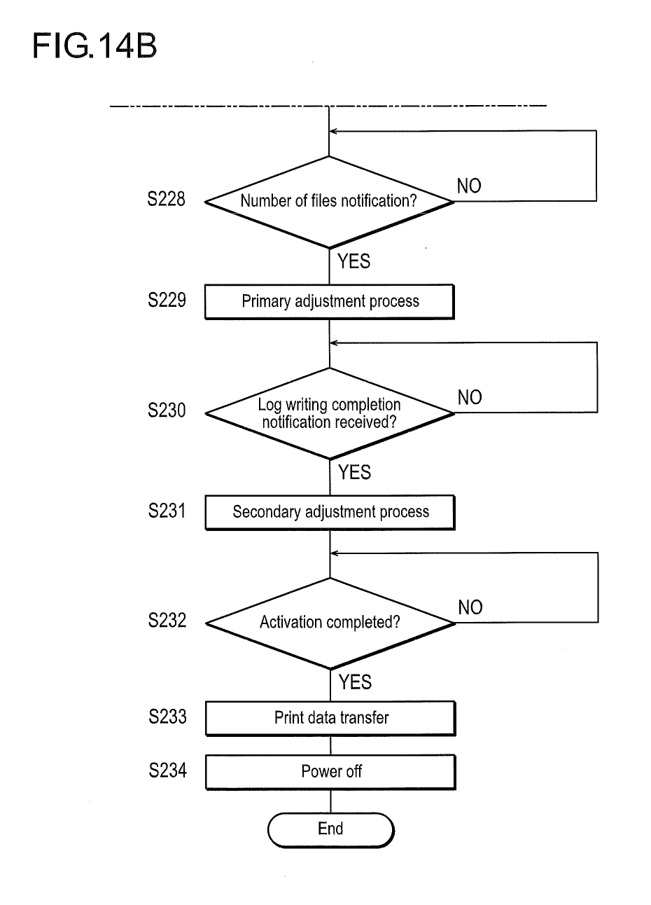

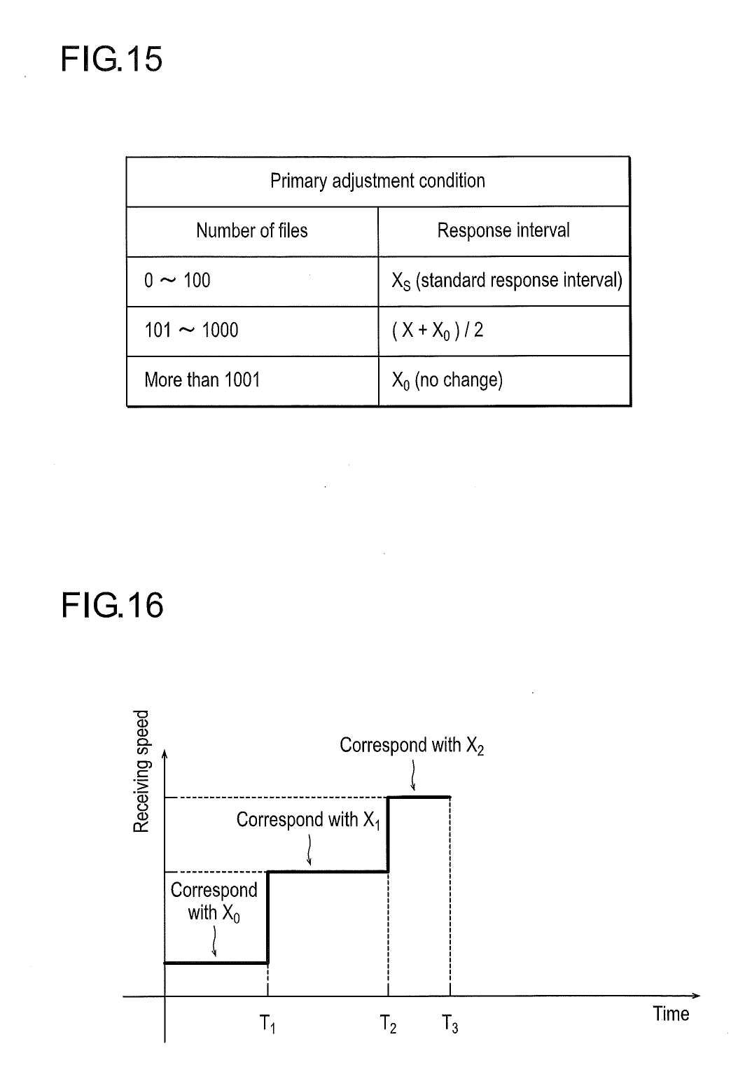

FIG. 14A and FIG. 14B represent a flowchart of assistance in explaining the receiving speed control by the CPU mounted on the sub-board shown in FIG. 12, and FIG. 15 is a table of assistance in explaining a primary adjustment condition of step S229 shown in FIG. 14B. The algorithm shown in the flowcharts of FIG. 14A and FIG. 14B is stored as the program in the ROM 254 and is executed by the CPU 252.

Since the process from step S221, wherein a judgment is made as to whether or not the start notification of the power-saving mode for the CPU 232 of the main-board 230 is received through step S227, wherein the receiving of the print data from the client terminal is started to be stored temporarily in the RAM 256, in the present embodiment substantially matches with the process from step S121 through S127 in the first embodiment, its description is omitted in order to avoid duplications.

The initial value of the response interval is set at the slowest speed (e.g., 3 seconds) as much as possible without causing a time-out on the transmitting side for the data. This is so as to reduce the risk of overflow of the print data because it is assumed that the period until the activation of the CPU 232 of the main-board 230 is completed becomes longer as the main-board 230 has the HDD 238 of a fixed type.

As the receiving of the print data from the client terminal starts and the print data is temporarily stored in the RAM 256 in step S227, a judgment is made as to whether or not the notification of the number of files stored in the HDD 236 (refer to step S208) is received (step S228). If the notification of the number of files is detected (step S228: Yes), the primary adjustment process is executed (step S229).

In the primary adjustment process, the response interval is adjusted to a value that corresponds with the number of files based on the condition shown in FIG. 15. The first re-evaluation of the receiving speed of the print data is executed at the time point T₁ when the number of files stored in the HDD 236 is notified to the CPU 252 of the sub port unit 250, and the receiving speed is modified by adjusting the response interval based on the number of files. The reason for taking the number of files stored in the HDD 236 into consideration is that it affects the initialization process time of the OS, and increases the activation time of the CPU 232 of the main-board 230. The response interval modified in the primary adjustment process is referred to as X₁.

For example, the response interval is set to X_{S} if the number of files is less than 100, to (Xₛ+X₁)/2 if the number of files is equal or greater than 101 and less than or equal to 1000, and to X₁ (no change) if the number of files is equal or greater than 1001. The response interval X_{S} is an actual time period spent until the activation of the CPU 232 of the main-board 230 is completed under a condition where no file is stored in the HDD 236. The condition of the primary adjustment process, or the corresponding relation between the number of files and the response interval is not limited to what is shown in FIG. 15.

A judgment is made as to whether or not the completion notification for the log information writing (refer to step S210) is received (step S230). If the completion notification for the log information writing is detected (step S230: Yes), the secondary adjustment process is executed (step S231).

In the secondary adjustment, the response interval is adjusted to a value corresponding to the free space in the RAM 256. The secondary re-evaluation of the response interval is executed at the time point T₂ when the completion of the log information writing is notified to the CPU 252 of the sub-board 250, and the response interval is adjusted in accordance with the free space of the RAM 256 of the sub-board 250. The time period from the time point T₂ when the log information writing is completed until the time point T₃ when the activation of the CPU 232 of the main-board 230 is completed is substantially constant as it is when the processes that are not affected by the number of files stored in the HDD 236 are executed. Consequently, the response interval X₃ modified in the secondary adjustment process can be calculated by a formula X₃=(T₃−T₂)/(M/m) where M (byte) is the free space of RAM 256 and m (byte) is the packet size.

After that, a judgment is made as to whether or not the completion notification of the activation of the CPU 232 of the main-board 230 (refer to step S212) is received (step S232). When the completion notification of the activation is detected (step S232: Yes), the storing of the print data is stopped, and the print data that is temporarily stored in the RAM 256 is transferred to the main-board 230 (step S233).

Then, all the functions of the CPU 252 are stopped and the power is turned off (step S234). The print data from then on is transferred from the client terminal via the communication interface 258, passing through the sub-board 250, to the main-board 230.

Next, let us describe an example of the receiving speed control.

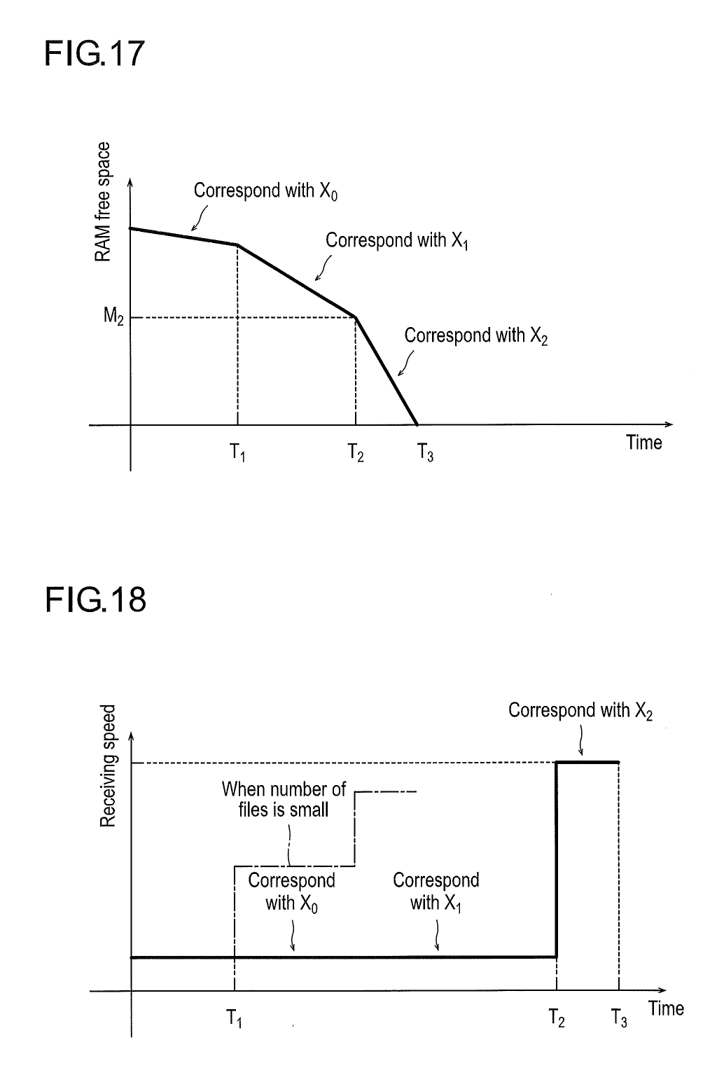

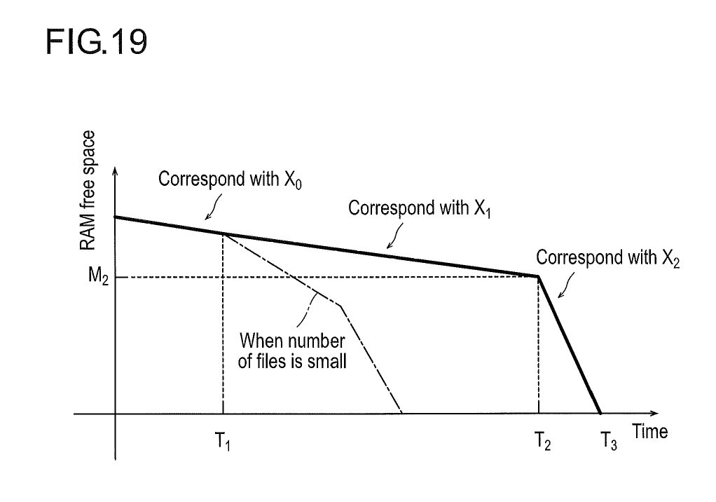

FIG. 16 and FIG. 17 are the graphs of assistance in explaining the transition of the receiving speed and the transition of the free space of the RAM of the sub-board respectively in case when the number of files stored in the HDD of the main-board is small, while FIG. 18 and FIG. 19 are the graphs of assistance in explaining the transition of receiving speed and the transition of free space of the RAM of the sub-board respectively in case when the number of files stored in the HDD of the main-board is large.

For example, if the number of files stored in the HDD 236 of the main-board 230 is small, the log information writing is completed quickly, so that it is possible to increase the receiving speed at the time point T₁ when the number of files is notified as shown in FIG. 16. As a result, the receiving speed can be increased by adjusting the response interval shorter. The receiving speed is further increased at the log information writing completion time T₂ to a value that corresponds to the response interval X₃ which was modified at the secondary adjustment process. Therefore, the print data can be received within a short period of time. The speed of free space reduction of the RAM 256 increases with the increase of the receiving speed as shown in FIG. 17.

On the other hand, if the number of files is large, the log information writing completion is delayed so that the response interval is not changed by the primary adjustment process and the process continues with the initial speed as shown in FIG. 18 at the time point T₁ when the number of files is notified. The receiving speed is then increased at the log information writing completion time T₂ to a value that corresponds to the response interval X₃ which was modified at the secondary adjustment process. Therefore, the print data's overflow can be avoided. The speed of free space reduction of the RAM 256 varies with the increase of the receiving speed as shown in FIG. 19.

As can be seen from the above, the second embodiment makes it possible to reduce power consumption and receive the print data more efficiently by modifying the response interval considering the effects of the number of files and the actual time period halfway through the activation (time until the log information writing completion notification).

It is also possible to constitute the system in such a manner as to control the receiving speed considering only either one of the number of files and the actual time period halfway through the activation (time until the log information writing completion notification).

It is obvious that this invention is not limited to the particular embodiments shown and described above but may be variously changed and modified without departing from the technical concept of this invention. For example, the print data receiving apparatus shall not be construed to be limited to the form to be added to a dedicated printer, but rather it can be applied to an MFP (Multi-Function Peripheral) having copying, printing, and scanning functions.

Also, the means, methods, and programs according to the present invention can be realized by a dedicated hardware circuit. Moreover, in case when the present invention is to be materialized using a programmed computer device, the program that operates the computer device can be provided by means of a computer readable recording medium such as a USB memory, a CD-ROM (Compact Disc Read Only Memory) or on-line via a network such as the Internet without using a recording medium. In such a case, the program is typically transmitted to and stored in a random access storage device such as a hard disk of the computer device. Also, the above program can be either provided as independent application software or can be built into the software of the computer device as one of its function.

What is claimed is:

1. A print data receiving apparatus for receiving print data from an external comprising:
a first arithmetic unit that controls at least a first storage device for storing said print data; and
a second arithmetic unit that issues an activation command to said first arithmetic unit when said second arithmetic unit detects receipt of said print data from the external under a power saving mode that stops operation of said first arithmetic unit, and controls a second storage device for temporarily storing said print data that is received, wherein
said second arithmetic unit consumes less power than said first arithmetic unit and controls a receiving speed of said print data in such a manner as to cause a free space of said second storage device to be used up when an activation of said first arithmetic unit is completed.

2. The print data receiving apparatus as claimed in claim 1, wherein the control of said receiving speed is executed by adjusting a response interval defined as a time period from when a packet constituting said print data is received until an ack signal is returned.

3. The print data receiving apparatus as claimed in claim 2, wherein said response interval is adjusted based on specification of said first storage device.

4. The print data receiving apparatus as claimed in claim 3, wherein said first storage device is removable, and an initial value of said response interval is calculated from a standard time period until the activation of said first arithmetic unit is completed under a condition in which said first storage device is not mounted and a capacity of said first storage device.

5. The print data receiving apparatus as claimed in claim 2, wherein said response interval is adjusted based on a number of files stored in said first storage device.

6. The print data receiving apparatus as claimed in claim 5, wherein said first storage device is a hard disk device of a fixed type, and an initial value of said receiving speed is set to a minimum speed at which time-out does not occur on a transmitting side for said print data.

7. The print data receiving apparatus as claimed in claim 2, wherein said response interval is adjusted based on an actual time period halfway through the activation of said first arithmetic unit.

8. The print data receiving apparatus as claimed in claim 1, wherein said print data stored in said second storage device is transmitted to said first storage device after the activation of said first arithmetic unit is completed.

9. The print data receiving apparatus as claimed in claim 1, wherein said second arithmetic unit is activated only under said power saving mode.

10. A print data receiving method for receiving print data from an external comprising:
in case when receipt of said print data from the external is detected under a power saving mode in which a first arithmetic unit for controlling at least a first storage device that stores said print data is stopped, a step of issuing an activation command to said first arithmetic unit by a second arithmetic unit that consumes less power than said first arithmetic unit, and controlling a second storage device for temporarily storing said print data that is received,
wherein a receiving speed of said print data is controlled in said step in such a manner as to cause a free space of said second storage device to be used up when an activation of said first arithmetic unit is completed.

11. The print data receiving method as claimed in claim 10, wherein the control of said receiving speed is executed by adjusting a response interval defined as a time period from when a packet constituting said print data is received until an ack signal is returned.

12. The print data receiving method as claimed in claim 11, wherein said response interval is adjusted based on specification of said first storage device.

13. The print data receiving method as claimed in claim 12, wherein said firs storage device is removable, and an initial value of said response interval is calculated from a standard time period until the activation of said first arithmetic unit is completed under a condition in which said first storage device is not mounted and a capacity of said first storage device.

14. The print data receiving method as claimed in claim 11, wherein said response interval is adjusted based on a number of files stored in said first storage device.

15. The print data receiving method as claimed in claim 14, wherein said first storage device is a hard disk device of a fixed type, and an initial value of said receiving speed is set to a minimum speed at which time-out does not occur on a transmitting side for said print data.

16. The print data receiving method as claimed in claim 11, wherein said response interval is adjusted based on an actual time period halfway through the activation of said first arithmetic unit.

17. The print data receiving method as claimed in claim 10, wherein said print data stored in said second storage device is transmitted to said first storage device after the activation of said first arithmetic unit is completed.

18. The print data receiving method as claimed in claim 10, wherein said second arithmetic unit is controlled to operate only under said power saving mode.

19. A computer readable recording medium stored with a print data receiving program for controlling a print data receiving apparatus comprising a first arithmetic unit for controlling at least a first storage device for receiving print data from an external and storing said print data, and a second arithmetic unit for controlling a second storage device for temporarily storing said print data in which said second arithmetic unit consumes less power than said first arithmetic unit, the print data receiving program causing said print data receiving apparatus to execute a process comprising:
a step of, in case when receipt of said print data from the external is detected under a power saving mode in which said first arithmetic unit is stopped, issuing an activation command to said first arithmetic unit and controlling said second storage device to temporarily store said print data that is received by means of said second arithmetic unit,
wherein a receiving speed of said print data is controlled in said step in such a manner as to cause a free space of said second storage device to be used up when an activation of said first arithmetic unit is completed.

20. The computer readable recording medium as claimed in claim 19, wherein the control of said receiving speed is executed by adjusting a response interval defined as a time period from when a packet constituting said print data is received until an ack signal is returned.

21. The computer readable recording medium as claimed in claim 20, wherein said response interval is adjusted based on specification of said first storage device.

22. The computer readable recording medium as claimed in claim 21, wherein said first storage device is removable, and an initial value of said response interval is calculated from a standard time period until the activation of said first arithmetic unit is completed under a condition in which said first storage device is not mounted and a capacity of said first storage device.

23. The computer readable recording medium as claimed in claim 20, wherein said response interval is adjusted based on a number of files stored in said first storage device.

24. The computer readable recording medium as claimed in claim 23, wherein said first storage device is a hard disk device of a fixed type, and an initial value of said receiving speed is set to a minimum speed at which time-out does not occur on a transmitting side for said print data.

25. The computer readable recording medium as claimed in claim 20, wherein said response interval is adjusted based on an actual time period halfway through the activation of said first arithmetic unit.

26. The computer readable recording medium as claimed in claim 19, wherein said print data stored in said second storage device is transmitted to said first storage device after the activation of said first arithmetic unit is completed.

27. The computer readable recording medium as claimed in claim 19, wherein said second arithmetic unit is controlled to operate only under said power saving mode.
